(19) United States
(12) Patent Application Publication
(10) Pub. No.: US 2006/0097138 A1
(43) Pub. Date: May 11, 2006

(54) Optical pointing sensor and cursor control method thereof

(75) Inventors: Kuo-Tong Ma, Taipei (TW); Pin-Chien Liao, Taoyuan County (TW)

Correspondence Address: QUINTERO LAW OFFICE, 1617 BROADWAY, 3RD FLOOR, SANTA MONICA, CA, 90404, US

(73) Assignee: DARFON ELECTRONICS CORP., TAOYUAN (TW)

(21) Appl. No.: 11/270,277

(22) Filed: Nov. 9, 2005

(30) Foreign Application Priority Data
Nov. 10, 2004 (TW) TW93134256

(51) Int. Cl. G06M 7/00; G02F 1/01

(52) U.S. Cl. 250/221; 250/225

(57) ABSTRACT

A cursor control method for an electronic device. The electronic device comprises a detecting window and a cursor shown on a monitor. An object is disposed on the detecting window. A laser diode with a laser cavity is provided to generate a plurality of laser beams with different polarization in a plurality of continuous time periods. A first and a second laser beams are guided to the detecting window, to impinge on the object along first and second incident axes, which reflects the first and second laser beams causing them to re-enter the laser cavity. A converting unit converts the electric variation of laser cavity caused by a self-mixing effect and Doppler periods into first and second electric signals to determine the displacement of the cursor.

### BACKGROUND

The invention relates to an optical pointing sensor, and in particular to an optical pointing sensor employing a self-mixing effect and time division multiplexing.

A conventional mouse emits beams via a light emitter. The beams are reflected by an object and received by an optical receiver. Relative displacement between the optical mouse and the object, which is used to control the positioning of a cursor on a monitor, is obtained by analysis of the reflected beam signal, as disclosed in U.S. Pat. No. 6,246,482, U.S. Pat. No. 6,330,057, U.S. Pat. No. 6,424,407 and U.S. Pat. No. 6,452,683.

Additionally, European Patent No. EP-A0 942 285 discloses a modified optical input device comprising an optical detecting module, which is typically disposed in an optical mouse, disposed in an arbitrary electronic device, such as a keyboard, a laptop or a personal digital assistant. A transparent window is disposed on a housing of the electronic device. When a finger moves on the transparent window, the relative displacement between the finger and the transparent window is available via optical detecting of a conventional optical mouse to control the cursor or other pointing devices.

Because the conventional optical detecting module requires a light emitter and a light receiver and the positions thereof must be predetermined, the optical detecting module occupies considerable space and may be not be applicable in compact electronic devices.

An embodiment of cursor control method of the invention, for an electronic device comprising a detecting window on which an object is disposed and a cursor shown on a monitor, comprises the following steps:

A laser diode with a laser cavity, which generates a plurality of laser beams with different polarization in a plurality of continuous time periods, is provided.

A first laser beam is guided to the detecting window and impinges on the object along a first incident axis, which reflects the first beam causing it to re-enter the laser cavity.

Electric variation in the laser cavity in a plurality of first time periods is measured to generate a plurality of first electric signals.

A second laser beam is guided to the detecting window and impinges on the object along a second incident axis, which reflects the second beam causing it to re-enter the laser cavity.

Electric variation in the laser cavity in a plurality of second time periods is measured to generate a plurality of second electric signals.

Displacements of the object in the first and second incident axes respectively are obtained from the first and second electric signals.

The displacement component in a first measuring axis and a second measuring axis are calculated from the displacements in the first and second incident axes to determine displacement of the cursor.

The cursor control method further comprises the following step:

The displacement component in a third measuring axis is calculated from the predetermined angle and the first and second incident axes, wherein the first measuring axis, the second measuring axis and the third measuring axis are orthogonal. When the displacement component of the object in the third measuring axis exists, the displacement component of the object defines a select signal.

The cursor control method further comprises the following step:

A third laser beam is guided to the detecting window. When the third laser beam is reflected into the laser cavity, the displacement components in the first and second measuring axes define a scroll signal.

The angle between the first and second incident axes is between 75° and 150°. The first incident axis has a predetermined angle between 0° and 45° with respect to the detecting window, and the second incident axis has a predetermined angle between 0° and 45° with respect to the detecting window.

An embodiment of an electronic device of the invention comprises a main body having a monitor displaying a cursor, and an optical pointing sensor with a detecting window bearing an object. The optical pointing sensor comprises a laser diode, a second optical path, a detecting unit, a converting unit and an operation unit. The laser diode having a laser cavity generates a plurality of laser beams of different polarization in a plurality of continuous time periods. The first optical path guides a first laser beam to the detecting window to impinge on the object along a first incident axis, which reflects the first beam causing it to re-enter the laser cavity. The second optical path guides a second laser beam to the detecting window, to impinge on the object along a second incident axis, which reflects the second beam to re-enter the laser cavity. The detecting unit measures the electric variation of the laser cavity in a plurality of first and second time periods and generates a plurality of first and second electric signals, wherein the electric variation is caused by the Doppler effect of the first and second laser beam. The converting unit obtains displacements of the object in the first and second incident axes respectively from the first and second electric signals. The operation unit calculates the displacement component in a first measuring axis and a second measuring axis from the displacements in the first and second incident axes.

The operation unit calculates the displacement component in a third measuring axis from the predetermined angle and the first and second incident axes. The first measuring axis, the second measuring axis and the third measuring axis are orthogonal. When the displacement component of the object in the third measuring axis exists, the displacement component of the object defines a select signal.

A first optical guider and a first polariscope having first polarization on the first optical guider are disposed in the first optical path. A second optical guider and a second polariscope having second polarization on the second optical guider are disposed on the second optical path.

The optical detecting device further comprises a third optical path on which a third optical guider and a polariscope having a third polarization on the third optical guider are disposed to guide a third laser beam to the detecting window and re-enter the laser cavity. When the third laser beam is reflected into the laser cavity, the displacement components in the first and second measuring axes define a scroll signal.

The first, second and third optical guiders are optical fibers.

The optical detecting sensor further comprises an optical coupling unit disposed between the laser diode, the first, second and third optical paths to couple the first, second and third laser beams into the first, second and third optical paths and guide the first, second and third laser beams re-entering the laser cavity.

The first incident axis intersects the second incident axis at a measuring point. The angle between the first and second incident axes is between 75° and 150°. The first incident axis has a predetermined angle between 0° and 45° with respect to the detecting window, and the second incident axis has a predetermined angle between 0° and 45° with respect to the detecting window. In addition, the first incident axis and the second axis cannot intersect.

The detecting unit can be a voltage sensor or current sensor for measuring electric variation in the laser cavity and outputting a corresponding signal. The operation unit and the control unit can be integrated into a micro-controller.

### BRIEF DESCRIPTION OF THE DRAWINGS

The invention can be more fully understood by reading the subsequent detailed description and examples with references made to the accompanying drawings, wherein:.

FIG. 1A is a side view of an optical pointing sensor of the invention;

FIG. 1B is a top view of FIG. 1A;

FIG. 1C is a schematic view depicting focusing of the first laser beam and the second laser beam at different points;

FIG. 2 is an operation sequence diagram of the optical pointing sensor of the invention;

FIG. 3A is a schematic view of the optical pointing sensor in the first time period;

FIG. 3B is a schematic view of the optical pointing sensor in the second time period;

FIG. 4 depicts the measuring circuit of the optical pointing sensor of the invention;

FIG. 5 depicts an electronic device with the optical pointing sensor of the invention;

FIGS. 6A-6D depict various embodiments of the optical pointing sensor of the invention;

FIG. 7 depicts another embodiment of the electronic device of the invention.

### DETAILED DESCRIPTION

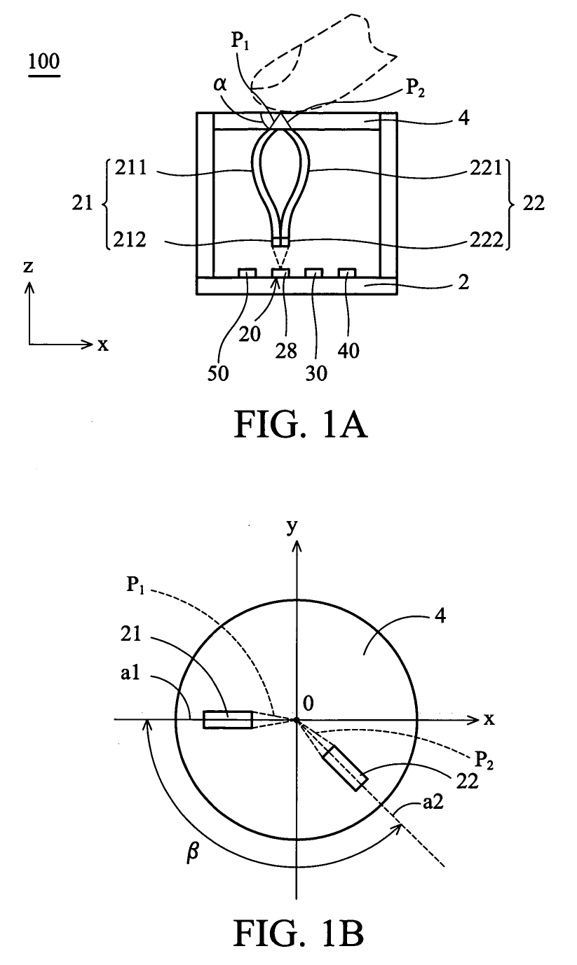

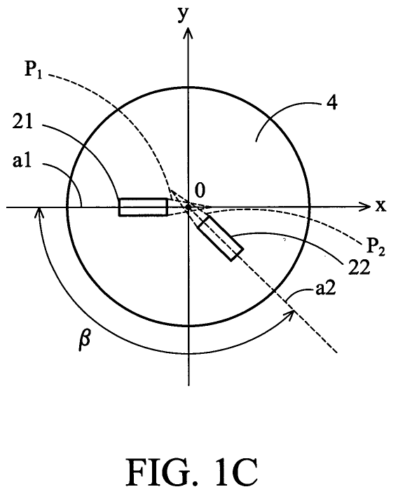

Referring to FIGS. 1A and 1B, an optical pointing sensor 100 is used to detect displacement components in measuring axes of an object, such as a finger, on a detecting window. The optical pointing sensor 100 comprises a first optical path 21, a second optical path 22, and a laser diode 20 on a substrate 2, a detecting unit 30, a converting unit 40 and an operation unit 50.

The laser diode 20, as disclosed in U.S. Pat. No. 5,465,263, can change the characteristics of a laser cavity 28 via external voltage or digital control to generate laser beams with different polarization. Thus the optical pointing sensor 100 controls the laser diode 20 via a simple circuit to generate laser beams with different polarization in a plurality of time periods, which serves as a detecting light source.

The optical pointing sensor 100 comprises a first optical path 21 and a second optical path 22. The front of the first optical path 21 is adjacent to the front of the second optical path 22, and both fronts are aligned with the laser diode 20 to couple the laser beam from the laser diode 20 and guide the laser beam to the detecting window 4 and the object. The first optical path 21 comprises a first light guider 211 and a first polariscope 212 disposed at the front of the first light guider 211. The second optical path 22 comprises a second light guider 221 and a second polariscope 222 disposed at the front of the second light guider 221. Only a first laser beam P1 with first polarization is allowed to pass through the first optical path 21, and only a second laser beam P2 with second polarization is allowed to pass through the second optical path 22. The first and second light guider 221 and 222 are optical fibers. As the first and second optical paths 21 and 22 extend to the bottom of the detecting window 4 respectively, the first laser beam P1 passes through the first optical path 21 along a first incident axis a1 to the object, and the second laser beam P2 passes through the second optical path 22 along a second incident axis a2 to the object.

The laser diode 20 serves as a light receiver. Part of the laser beams reflected or scattered by the object pass through the first optical path 21 or the second optical path 22 and re-enter the laser cavity 28 of the laser diode 20 causing a self-mixing effect in the laser cavity 28 resulting in electric variation in the laser cavity 28. Reference to the self-mixing-effect can be found in following documents, “Small laser Doppler velocimeter based on the self-mixing effect in a diode laser”, Applied Optics, Vol. 27, No. 2, Jan. 15, 1988, Pages 379-385 and “Laser Doppler velocimeter based on the self-mixing effect in a fiber-coupled semiconductor laser”, Applied Optics, Vol. 31, No. 8, Jun. 20, 1992, Pages 3401-3408.

Referring to the cited documents, when the object moves with respect to the laser diode 20, the frequency of the reflected laser beam changes due to the Doppler Effect. The laser diode 20 generates a variation Δg due to the self-mixing effect. The variation Δg has the following correlation:

$$Δ g = - \frac{K}{L} \cdot ( \frac{4 π \cdot v \cdot f \cdot t}{c} + \frac{4 π \cdot {L}_{0} \cdot t}{c} )$$

wherein K is a coupling constant of the laser cavity 28 and the reflected laser beam, v is the speed of the object with respect to the laser diode 20, f is a primary frequency, t is the time period and c is the light velocity.

The variation Δg can be measured via the detecting unit 30, which generates an electric signal. The Doppler Effect modulates the frequency of the electric signal. The electric signal is digitized by the converting unit 40 and calculated by the operation unit 50 to obtain the displacement of the object in the first incident axis al and the second incident axis a2 to acquire the displacement components in the first measuring axis x, the second measuring axis y and the third measuring axis z.

In FIGS. 1A and 1B, the first incident axis al and the second incident axis a2 intersects at a measuring point O. The first incident axis a1 and the second incident axis a2 have a predetermined angle α which is from 0° to 75°. The angle β between the first and second incident axes a1 and a2 is from 75° to 150°. The displacement in the first incident axis a1 and the second incident axis a2 can be obtained by the geometric relationship between the first incident axis a1, the second incident axis a2 and the detecting window 4. The displacement includes distance, velocity and direction. The displacement component in the first measuring axis x and the second measuring axis y can be calculated via the geometric relationship between the first incident axis a1, the second incident axis a2 and the detecting window 4. Additionally, in FIG. 1C, it is possible that the first laser beam P1 and the laser beam P2 are focused at a point near the measuring point O rather than the measuring point O.

Although the optical pointing sensor 100 has only two incident axes, the operation unit 50 is capable of determining the displacement component in the z axis via angle α and β. When the displacement has a component in the z axis, the displacement defines a select signal, whereby the optical pointing sensor 100 is able to detect the x-y displacement component and the selecting operation. The detecting window can be a virtual surface or a physical surface, such as a surface comprised of transparent material (glass or plastic).

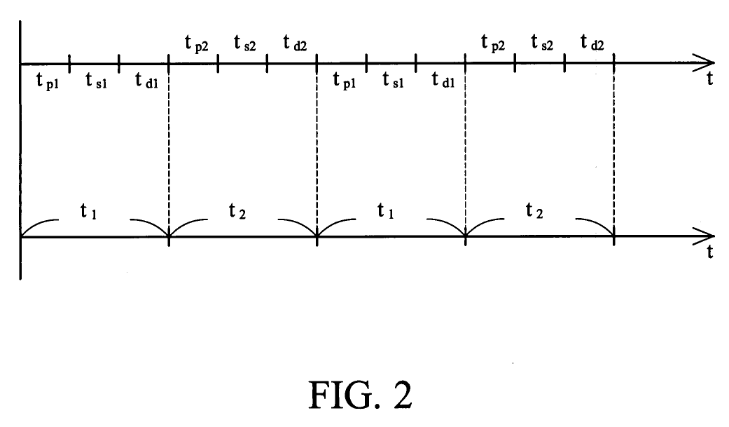

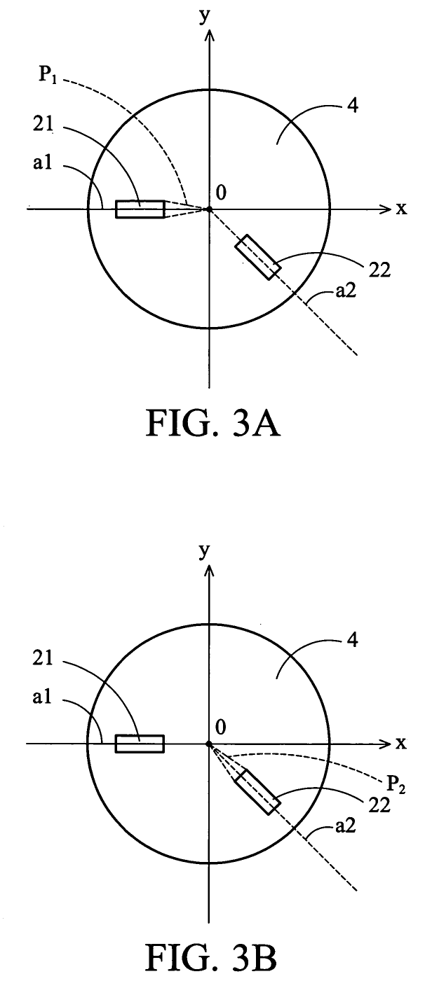

Referring to FIGS. 2 and 3A, a first time period t1 can be divided into three sub-time periods, tp1, ts1 and td1. In period tp1, the laser diode 20 provides the first laser beam P1 passing through the first optical path 21 along the first incident axis to the object, and the reflected laser beam passing through the first optical path 21 re-enters the laser cavity 28. In period ts1, the laser diode 20 creates a variation due to self-mixing effect. In period td1, the detecting unit 30, converting unit 40 and the operation unit 50 acquire the displacement in the first incident axis a1. In FIGS. 2 and 3B, the first time t2 can be divided into three sub time periods, tp2, td2 and td2. In period tp2, the laser diode 20 provides the second laser beam P1 passing through the second optical path 22 along the second incident axis to the object, and the reflected laser beam passing through the second optical path 22 re-enters the laser cavity 28. In period ts1, the laser diode 20 creates a variation due to self-mixing effect. In period td1, the detecting unit 30, converting unit 40 and the operation unit 50 acquire the displacement in the second incident axis a2. The displacement components in the first measuring axis x, the second measuring axis y and the third measuring axis z is available via the operation unit 50.

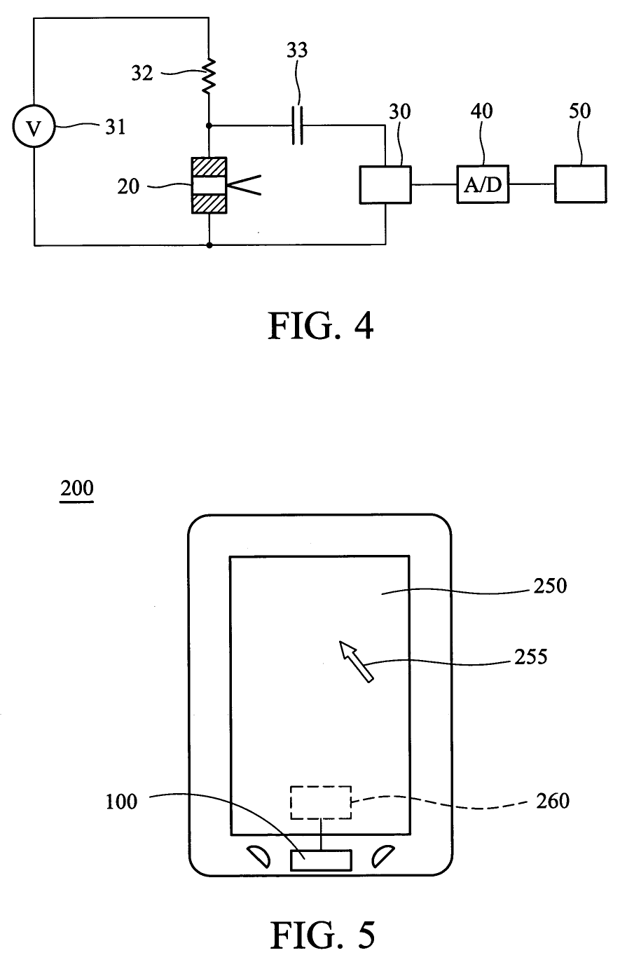

FIG. 4 depicts a measuring circuit of the optical pointing sensor. The laser diode 20 is serially connected to a voltage source 31 and a resistance 32 to serve as a voltage divider. In this embodiment, the detecting unit 30 is a voltage sensor serially connected to a capacitor 33 to shield high frequency noise. When the laser diode 20 generates a variation Δg, the detecting unit 30 detects a voltage variation which is converted into a digital signal comprising distance, velocity and direction via the converting unit 40. The operation unit 50 calculates the digital signal to obtain the displacement component in the measuring axes. The detecting unit 30 can be a current sensor, and the detecting method is well known.

FIG. 5 depicts an electronic device with the optical pointing sensor of the invention. As the optical pointing sensor is so compact, it is applicable to handheld devices, such as laptops, cell phones, personal digital assistants and a remote control unit for controlling a cursor. For the sake of simplicity, only a personal digital assistant is cited in FIG. 5.

In FIG. 5, a personal digital assistant (PDA) 200 has a screen 250 displaying a cursor 255. The optical pointing sensor 100 is disposed under the screen 250 and connected to a control unit 260 of the PDA 200. When a finger moves on the optical pointing sensor 100, control unit 260 moves the cursor 255 according to the x and y displacement measured by the optical pointing sensor 100 and determines the select signal according to z displacement.

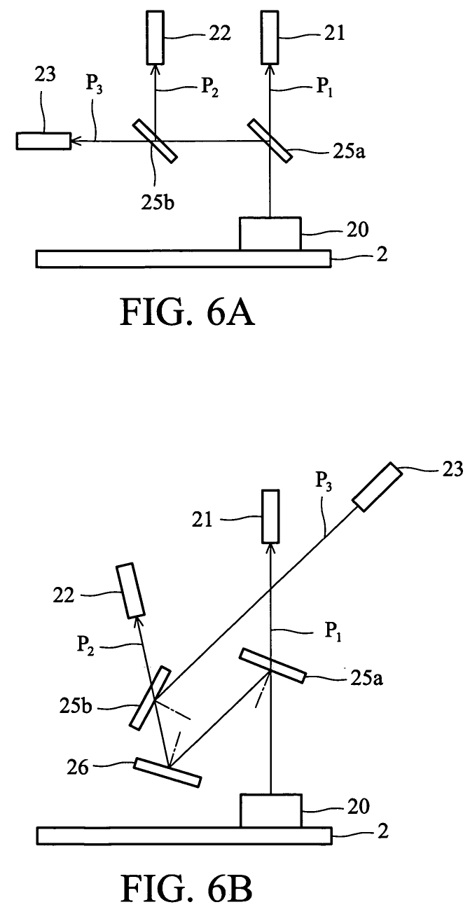

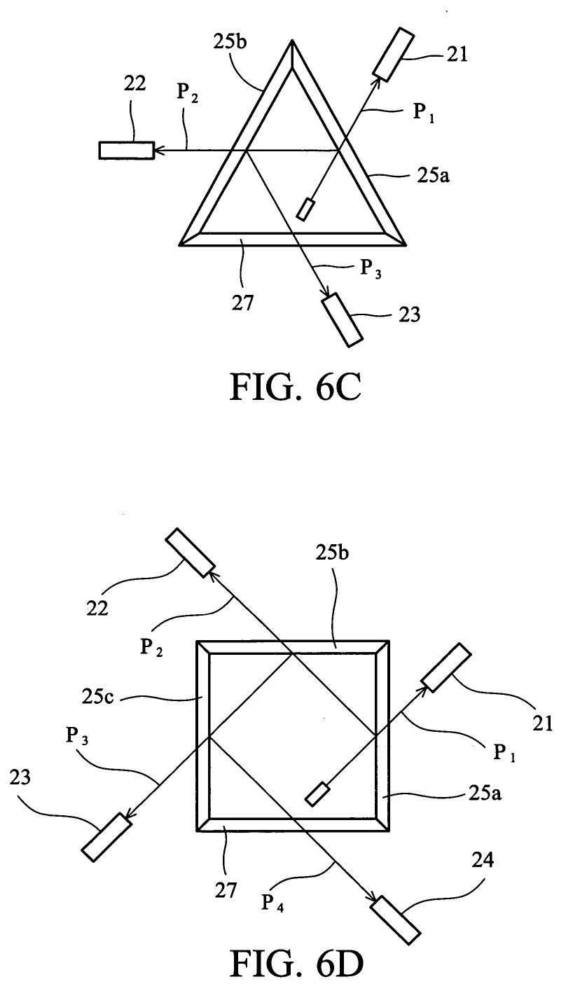

FIGS. 6A to 6D depict various other embodiments of the optical pointing sensor comprising optical coupling units coupling laser beams with different polarizations into different optical paths. Referring to FIG. 6A, the optical pointing sensor has a first polariscope 25a and a second polariscope 25b. The first polariscope 25a allows only allows passage of the first laser beam P1 with the first polarization therethrough and reflects other laser beams with other polarization. The second polariscope 25b only allows passage of the third laser beam P3 with third polarization therethrough and reflects other laser beams with other polarization. The first, second and third laser beam sP1˜P3 are coupled into the first, second and third optical paths 21, 22 and 23 to measure displacement of an object in three incident axes for cursor control.

The embodiment of the optical coupling unit of FIG. 6B, similar to that of FIG. 6A, comprises two polariscopes 25a and 25b and a reflective mirror 26 which improves the design of the optical path and functions to split the laser beams.

FIG. 6C depicts an optical coupling unit comprising two polariscopes 25a and 25b and a lens 27 configured in a triangle. The laser diode 20 is disposed in the middle of the triangle. The incident direction of each laser beam has a 60° angle with respect to each lens, whereby the first, second and third laser beams P1˜P3 can be coupled into the first, second and third optical paths 21, 22 and 23.

FIG. 6D depicts an optical coupling unit comprising three polariscopes 25a, 25b and 25c and a lens 27 configured in a square. The laser diode 20 is disposed in the middle of the square. The incident direction of each laser beam has a 45° angle with respect to each lens, whereby the first, second, third and fourth laser beams P1˜P4 can be coupled into the first, second, third and fourth optical paths 21, 22, 23 and 24.

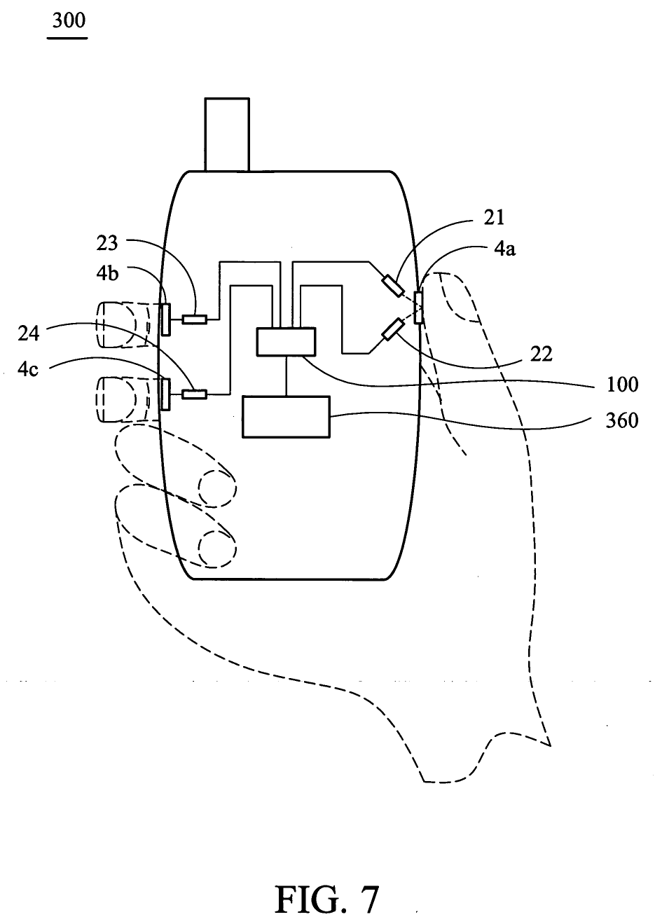

FIG. 7 depicts another embodiment of the electronic device of the invention. In this embodiment, a cell phone is cited. For the sake of simplicity, depiction of the screen and keypad thereof are omitted.

In FIG. 7, a mobile phone 300 comprises an optical pointing sensor 100, a control unit 360 and three detecting windows 4a, 4b and 4c. The first detecting window 4a is disposed on the right side of the cell phone 300. The second and third detecting windows 4b and 4c are disposed on the left side of the cell phone 300. When the cell phone 300 is held by a right hand, the thumb corresponds to the first detecting window 4a, the first finger corresponds to the second detecting window 4b and the second finger corresponds to the third detecting window 4c.

The optical pointing sensor 100 has four optical paths 21˜24. The first optical path 21 and the second optical path 22 are used to measure the thumb displacement in x, y and z axes on the first detecting window 4a. The third optical path 23 detects the first finger displacement in the z axis on the second detecting window 4b. The fourth optical path 24 detects the second finger displacement in the z axis on the second detecting window 4c. When the thumb moves with respect to the first detecting window 4a, control unit 360 controls the cursor on the screen to move or perform a select operation. When the first finger touches the second detecting window 4b or moves with respect to the z axis of the second detecting window 4b, the reflected laser beam of a third laser beam enters the laser cavity of the laser diode. The movement of the thumb on the first detecting window 4a can be defined as a scroll signal used to scroll the screen. When a second finger touches the third detecting window 4c or moves with respect to the z axis of the third detecting window 4c, the reflected laser beam of a fourth laser beam enters the laser cavity of the laser diode to perform a particular hot key operation or other function via control unit 360 or a software application program.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cursor control method for an electronic device comprising a detecting window on which an object is disposed and a cursor, which is shown on a monitor, comprising the following steps:
providing a laser diode with a laser cavity, generating a plurality of laser beams with different polarization in a plurality of continuous time periods;
guiding a first laser beam to the detecting window, to impinge on the object along a first incident axis, which reflects the first beam to re-enter the laser cavity;
measuring electric variation of the laser cavity in a plurality of first time periods and generating a plurality of first electric signals;
guiding a second laser beam to the detecting windows, to impinge on the object along a second incident axis, which reflects the second beam to re-enter the laser cavity;
measuring electric variation of the laser cavity in a plurality of second time periods and generating a plurality of second electric signals;
obtaining displacements of the object in the first and second incident axes respectively from the first and second electric signals; and
calculating the displacement component in a first measuring axis and a second measuring axis from the displacements in the first and second incident axes to determine displacement of the cursor.

2. The cursor control method as claimed in claim 1, wherein the first incident axis and the second incident axis intersect at a measuring point.

3. The cursor control method as claimed in claim 1, wherein the angle between the first and second incident axes is between 75° and 150°.

4. The cursor control method as claimed in claim 1, wherein the first incident axis has a predetermined angle between 0° and 45° with respect to the detecting window, and the second incident axis has a predetermined angle between 0° and 45° with respect to the detecting window.

5. The cursor control method as claimed in claim 1 further comprising the following step:
calculating the displacement component in a third measuring axis from the predetermined angle and the first and second incident axes, wherein the first measuring axis, the second measuring axis and the third measuring axis are orthogonal.

6. The cursor control method as claimed in claim 5 further comprising the following step:
when the displacement component of the object in the third measuring axis exists, the displacement component of the object defines a select signal.

7. The cursor control method as claimed in claim 5 comprising the following steps:
guiding a third laser beam to the detecting window; and
when the third laser beam is reflected into the laser cavity, the displacement components in the first and second measuring axes define a scroll signal.

8. An optical pointing sensor for measuring displacement components of an object on a detecting window in a plurality of measuring axes, comprising:
a laser diode with a laser cavity, generating a plurality of laser beams with different polarization in a plurality of continuous time periods;
a first optical path guiding a first laser beam to the detecting window, to impinge on the object along a first incident axis, which reflects the first beam to causing it to re-enter the laser cavity;
a second optical path guiding a second laser beam to the detecting window, to impinge on the object along a second incident axis, which reflects the second beam causing it to re-enter the laser cavity;
a detecting unit measuring the electric variation of the laser cavity in a plurality of first and second time periods and generating a plurality of first and second electric signals, wherein the electric variation is caused by the Doppler Effect of the first and second laser beam;
a converting unit obtaining displacements of the object in the first and second incident axes respectively from the first and second electric signals; and
an operation unit calculating the displacement component in a first measuring axis and a second measuring axis from the displacements in the first and second incident axes.

9. The optical pointing sensor as claimed in claim 8, wherein the first incident axis and the second incident axis intersect at a measuring point.

10. The optical pointing sensor as claimed in claim 8, wherein the angle between the first and second incident axes is between 75° and 150°.

11. The optical pointing sensor as claimed in claim 8, wherein the first incident axis has a predetermined angle between 0° and 45° with respect to the detecting window, and the second incident axis has a predetermined angle between 0° and 45° with respect to the detecting window.

12. The optical pointing sensor as claimed in claim 8, wherein the operation unit calculates the displacement component in a third measuring axis from the predetermined angle and the first and second incident axes, and the first measuring axis, the second measuring axis and the third measuring axis are orthogonal.

13. The optical pointing sensor as claimed in claim 8, wherein a first optical guider and a first polariscope having first polarization on the first optical guider are disposed in the first optical path, and a second optical guider and a second polariscope having a second polarization on the second optical guider are disposed on the second optical path.

14. The optical pointing sensor as claimed in claim 13 further comprising an optical coupling unit disposed between the laser diode, the first optical path and the second optical path to couple the first and second laser beams into the first and second optical paths and guide the first and second laser beams to re-enter the laser cavity.

15. The optical pointing sensor as claimed in claim 13 further comprising a third optical path on which a third optical guider and a polariscope having a third polarization on the third optical guider are disposed to guide a third laser beam to the detecting window and re-enter the laser cavity.

16. The optical pointing sensor as claimed in claim 15 further comprising an optical coupling unit disposed between the laser diode, the first, second and third optical paths to couple the first, second and third laser beams into the first, second and third optical paths and guide the first, second and third laser beams to re-enter the laser cavity.

17. The optical pointing sensor as claimed in claim 15, wherein the first, second and third optical guiders are optical fibers.

18. The optical pointing sensor as claimed in claim 8, wherein the detecting unit is a voltage sensor or a current sensor.

19. The optical pointing sensor as claimed in claim 8, wherein the operation unit is a microcontroller.

20. An electronic device having a cursor moving with respect to displacements of an object in a plurality of incident axes, comprising:
a main body;
an optical pointing sensor having a detecting window bearing the object, comprising:
a laser diode with a laser cavity, generating a plurality of laser beams with different polarization in a plurality of continuous time periods;
a first optical path guiding a first laser beam to the detecting window, to impinge on the object along a first incident axis, which reflects the first beam to causing it to re-enter the laser cavity;
a second optical path guiding a second laser beam to the detecting windows, to impinge on the object along a second incident axis, which reflects the second beam causing it to re-enter the laser cavity;
a detecting unit measuring the electric variation of the laser cavity in a plurality of first and second time periods and generating a plurality of first and second electric signals, wherein the electric variation is caused by the Doppler Effect of the first and second laser beam;
a converting unit obtaining displacements of the object in the first and second incident axes respectively from the first and second electric signals; and
an operation unit calculating the displacement component in a first measuring axis and a second measuring axis from the displacements in the first and second incident axes
a control unit moving the cursor based on the displacement components in the first and second measuring axes.

21. The electronic device as claimed in claim 20, wherein the first incident axis and the second incident axis intersect at a measuring point.

22. The electronic device as claimed in claim 20, wherein the angle between the first and second incident axes is between 75° and 150°.

23. The electronic device as claimed in claim 20, wherein the first incident axis has a predetermined angle between 0° and 45° with respect to the detecting window, and the second incident axis has a predetermined angle between 0° and 45° with respect to the detecting window.

24. The electronic device as claimed in claim 21, wherein the operation unit calculates the displacement component in a third measuring axis from the predetermined angle and the first and second incident axes, and the first measuring axis, the second measuring axis and the third measuring axis are orthogonal.

25. The electronic device as claimed in claim 24, wherein when the displacement component of the object in the third measuring axis exists, the displacement component of the object is determined as a select signal.

26. The electronic device as claimed in claim 20, wherein a first optical guider and a first polariscope having first polarization on the first optical guider are disposed in the first optical path, and a second optical guider and a second polariscope having second polarization on the second optical guider are disposed on the second optical path.

27. The electronic device as claimed in claim 26 further comprising an optical coupling unit disposed between the laser diode, the first optical path and the second optical path to couple the first and second laser beams into the first and second optical paths and guide the first and second laser beams to re-enter the laser cavity.

28. The electronic device as claimed in claim 26 further comprising a third optical path on which a third optical guider and a polariscope having a third polarization on the third optical guider are disposed to guide a third laser beam-to the detecting window and re-enter the laser cavity.

29. The electronic device as claimed in claim 28, wherein when the third laser beam is reflected into the laser cavity, the displacement components in the first and second measuring axes are determined as a scroll signal.

30. The electronic device as claimed in claim 29 further comprising an optical coupling unit disposed between the laser diode, the first, second and third optical paths to couple the first, second and third laser beams into the first, second and third optical paths and guide the first, second and third laser beams to re-enter the laser cavity.

31. The electronic device as claimed in claim 29, wherein the first, second and third optical guiders are optical fibers.

32. The electronic device as claimed in claim 20, wherein the detecting unit is a voltage sensor or a current sensor.

33. The electronic device as claimed in claim 20, wherein the operation unit is a microcontroller.
